(19) United States
(12) Patent Application Publication
(10) Pub. No.: US 2015/0229382 A1
(43) Pub. Date: Aug. 13, 2015

(54) SYSTEM OF SWITCHING MULTIANTENNA AND METHOD OF THE SAME

(71) Applicant: Electronics and Telecommunications Research Institute, Daejeon (KR)

(72) Inventors: Seung Yong LEE, Daejeon (KR); Hyung Joo KIM, Daejeon (KR); Dae Seung YOO, Busan (KR); Kyong Hee LEE, Daejeon (KR); Gwang Ja JIN, Daejeon (KR); Byung Tae JANG, Daejeon (KR); Dong Sun LIM, Daejeon (KR)

(73) Assignee: Electronics and Telecommunications Research Institute, Daejeon (KR)

(21) Appl. No.: 14/286,137

(22) Filed: May 23, 2014

(30) Foreign Application Priority Data
Feb. 11, 2014 (KR) 10-2014-0015198

(51) Int. Cl. H04B 7/08; H04B 7/04; H01Q 1/24

(52) U.S. Cl. CPC H04B 7/082; H01Q 1/24; H04B 7/0404; H04B 7/0808; H04B 7/0814

(57) ABSTRACT

An antenna switching system according to an exemplary embodiment of the present invention includes a plurality of directional antenna which is mounted in a ship to receive a wireless signal; an antenna switch which selects one of the plurality of directional antennas; a modem which is connected to the directional antennas through the antenna switch to extract a strength of a received signal; and a switching determining unit which outputs an antenna selection signal to the antenna switch based on the strength of the received signal and GPS/DR information of a transmission side ship and its own ship.

### CROSS-REFERENCE TO RELATED APPLICATIONS

This application claims priority to and the benefit of Korean Patent Application No. 10-2014-0015198 filed in the Korean Intellectual Property Office on Feb. 11, 2014, the entire contents of which are incorporated herein by reference.

### TECHNICAL FIELD

The present invention relates to a system and a method for switching multiantenna in a maritime wireless communication system.

### BACKGROUND ART

A maritime communication system is configured by MF (medium frequency), HF (high frequency), and VHF (very high frequency) band communication equipment and communication equipment using a satellite in order to communicate with a global maritime system and mainly provides a voice communication service except a short text message service. Recently, IMO (International Maritime Organization) takes a lead in establishment of an E-navigation strategy for building a maritime ITS (intelligent transportation system) which may accept data and multimedia by using an AIS (automatic identification system) communication network. Further, technologies such as a WLAN (wireless LAN) or a WiMAX (world interoperability for microwave access) to which a recent radio wave technology is reflected are considered for updating the maritime communication at a harbor and a ship and an AIS which uses a VHF band connected with the satellite emerges as a maritime infra communication network. Such a maritime communication system performs communication between the ground and a marine ship using one antenna corresponding to the ground and one antenna corresponding to a ship on the sea or communication between ships on the sea using an antenna corresponding to the ship on the sea and an antenna corresponding to another ship.

Generally, a communication apparatus which configures the maritime communication system has mainly an omnidirectional antenna structure which transmits and receives a signal in all directions. However, according to this structure, when a wireless communication apparatus having the omnidirectional antenna structure performs communication with a neighboring wireless communication apparatus, the wireless communication apparatus transmits all the signals to all neighboring wireless communications so that all wireless communication apparatuses within a communication range do not communicate but wait until the communication ends. As a result, a transmission delay or increased communication time may occur when the entire network is configured and operated such that network efficiency may be significantly lowered.

### SUMMARY

The present invention has been made in an effort to provide a system and a method which stably operate a plurality of directional antennas in a marine ship mounted with a plurality of directional antennas and omni antennas mounted therein in a maritime wireless communication system.

Technical objects of the present invention are not limited to the aforementioned technical objects and other technical objects which are not mentioned will be apparently appreciated by those skilled in the art from the following description.

An exemplary embodiment of the present invention provides a multiantenna switching system including: a plurality of directional antennas which is mounted in a ship to receive a wireless signal; an antenna switch which selects one of the plurality of directional antennas; a modem which is connected to the directional antennas through the antenna switch to extract a strength of a received signal; and a switching determining unit which outputs an antenna selection signal to the antenna switch based on the strength of the received signal and GPS/DR information of a transmission side ship and its own ship.

According to another exemplary embodiment, the GPS/DR information of the transmission side ship may be extracted and provided from the received signal by the modem.

According to another exemplary embodiment, the plurality of directional antennas may each have a predetermined coverage direction angle and be radially mounted in the ship so as to cover all directions.

According to another exemplary embodiment, the received signal which is received through the plurality of directional antennas may be transmitted through an omni antenna of the transmission side ship.

According to another exemplary embodiment, the switching determining unit may include: a distance/speed calculating module which generates information on a position (direction), a distance or a speed difference between both ships based on the GPS/DR information of the transmission side ship and its own ship; a direction information generating module which generates coverage direction angle information of each of the plurality of directional antennas based on the GPS/DR information of the transmission side ship and its own ship; and an antenna direction estimating module which generates an antenna selection estimating model based on the information on a position (direction), a distance or a speed difference from the distance/speed calculating module and the coverage direction angle information of each of the plurality of directional antennas from the direction information generating module.

According to another exemplary embodiment, the switching determining unit may further include: a searching module which searches information on a strength of a received signal which is received from the modem while sequentially selecting the plurality of directional antennas.

According to another exemplary embodiment, the searching module may search the information on the strength of the received signal through the plurality of directional antennas referring to the antenna selection estimating model.

An exemplary embodiment of the present invention provides a multiantenna switching method including: generating an antenna selection estimating model based on a coverage direction angle for every directional antenna and GPS/DR information of a transmission side ship and its own ship; searching a strength of a received signal for every directional antenna referring to the antenna selection estimating model; and selecting one of the plurality of directional antennas based on the strength of the received signal.

According to another exemplary embodiment, the method may further include monitoring whether the strength of the received signal maintains a threshold value while tracking the selected directional antenna; and returning to the searching of a strength of a received signal for every directional antenna, when the strength of the received signal is lower than a threshold value.

According to another exemplary embodiment, the returned searching of a strength of a received signal may include updating the antenna selection estimating model.

According to the exemplary embodiment of the present invention, the maritime wireless communication system uses a plurality of directional antennas and an omni antenna together to expand a communication distance between ships and adopts an antenna switching method without using separate expensive tracking equipment, thereby reducing a total cost of the system.

### BRIEF DESCRIPTION OF THE DRAWINGS

FIG. 1 illustrates a maritime wireless communication system according to an exemplary embodiment of the present invention.

FIG. 2 is a block diagram illustrating a directional antenna switching device according to an exemplary embodiment of the present invention.

FIG. 3 illustrates a plurality of directional antennas which is mounted in a ship according to an exemplary embodiment of the present invention.

FIG. 4 is a block diagram illustrating a detailed configuration of a switching determining unit according to an exemplary embodiment of the present invention.

FIG. 5 is a flowchart illustrating a multiantenna switching method according to an exemplary embodiment of the present invention. It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some embodiments of the present invention will be described in detail with reference to the accompanying drawings. When components in the drawings are denoted by reference numerals are, even though the components are illustrated in different drawings, it should be understood that like reference numerals refer to the same or equivalent components of the present invention throughout the several figures of the drawing. In describing the exemplary embodiments of the present invention, when it is determined that the detailed description of the known art related to the present invention may obscure the gist of the exemplary embodiments of the present invention, the detailed description thereof will be omitted.

In describing components of the exemplary embodiment of the present invention, terminologies such as first, second, A, B, (a), (b), and the like may be used. However, such a terminology is used only to distinguish a component from the other component but the nature or an order of the component is not limited by the terminology.

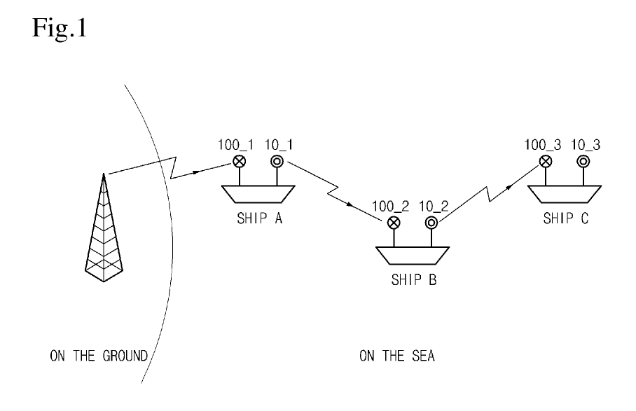

FIG. 1 illustrates a maritime wireless communication system according to an exemplary embodiment of the present invention.

A maritime wireless communication system according to an exemplary embodiment of the present invention has a configuration which provides a wireless communication service from a communication base station system position from land to ships (vessels) on the sea. To this end, each ship includes a transmitting antenna and a receiving antenna and has a basic configuration in that the transmitting antenna and the receiving antenna are connected as a relay to build a communication network.

Referring to FIG. 1, as compared with a communication system on the ground, three ships (a ship A, a ship B, and a ship C) on the sea are illustrated.

Each ship (the ship A, the ship B, and the ship C) on the sea includes an omni antenna for transmission and a plurality of directional antennas for reception. That is, a signal which is transmitted from a base station of the communication system on the ground is received by a directional antenna 100_1 of the ship A and then retransmitted by an omni antenna 10_1 of the ship A again.

It is obvious that a communication system of the ship A is configured to extract a wireless signal which is received from the communication system on the ground to obtain desired data and as illustrated in FIG. 1, the communication system may retransmit the received signal to another ship.

The wireless signal which is transmitted from the omni antenna 10_1 of the ship A is received by a directional antenna 100_2 of the ship B again and then retransmitted by an omni antenna 10_2 of the ship B to be transmitted by a directional antenna 100_3 of the ship C.

The omni antenna for transmission which is mounted in each of the ships (the ship A, the ship B, and the ship C) includes an omni antenna configuration having an omni directional characteristic with various structures.

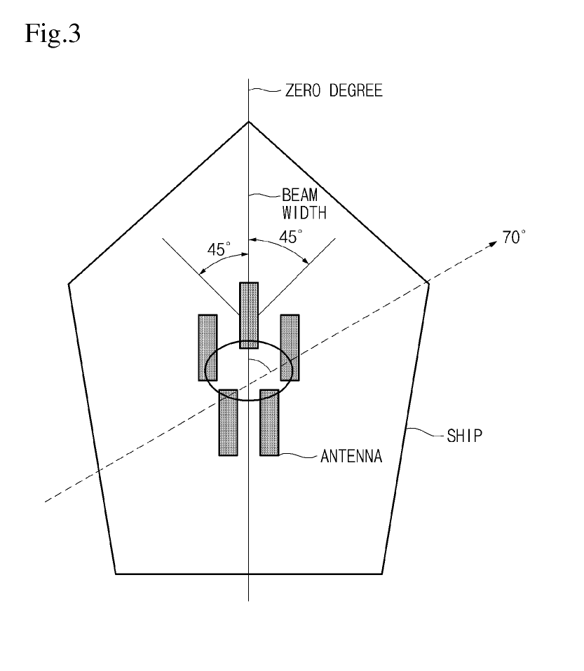

In the case of the directional antenna for reception which is mounted in each of the ships (the ship A, the ship B, and the ship C), a plurality of directional antennas is mounted in the ship at a predetermined angle and distance and an example of the mounting type will be illustrated in FIG. 3. The mounting type will be described below with reference to FIG. 3.

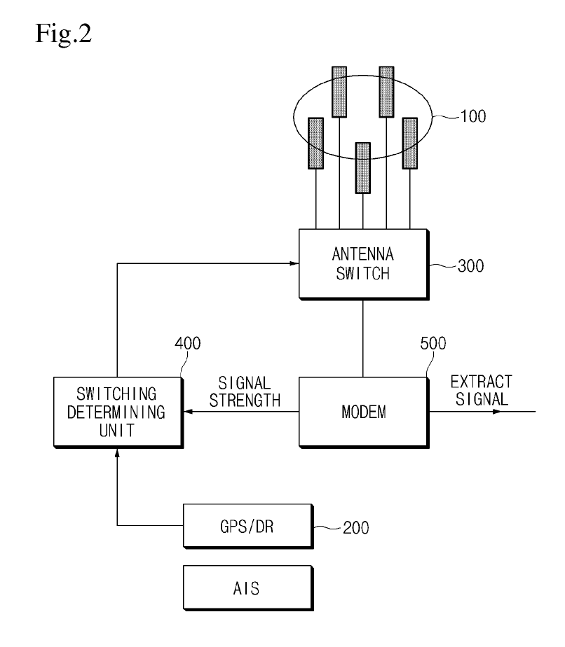

FIG. 2 is a block diagram illustrating a directional antenna switching device according to an exemplary embodiment of the present invention.

Referring to FIG. 2, the directional antenna switching device may include a plurality of directional antennas 100, a GPS/DR 200, an antenna switch 300, a switching determining unit 400, and a modem 500. Here, the directional antenna switching device may further include an AIS (automatic identification system).

As described above, the directional antenna 100 which is mounted to receive a signal of a ship (vessel) is configured by a plurality of directional antenna sectors each having a predetermined coverage and each of the directional antenna sectors is designed to have a predetermined beam width (for example, 90 degrees) and a predetermined radiation distance (for example, 1 km). As it will be described below with reference to FIG. 3, a method that arranges the plurality of directional antenna sectors is also desirably designed to have a coverage of all directions of 360 degrees on the sea.

The GPS/DR 200 provides information on a position, a speed, and a direction angle when the ship moves or stops. Further, a DR is coupled to a GPS to estimate/correct direction angle information which is generated from the GPS even when the ship stops. Such GPS/DR information of the ship is transmitted together when a wireless signal is transmitted, and even when a wireless signal of another ship is transmitted, GPS/DR information of the other ship may be obtained through a signal extracting process. Its own GPS/DR information of the ship is used together with the GPS/DR information of the other ship obtained as described above to obtain and estimate information such as a relative position, a speed, and a direction angle between ships.

The antenna switch 300 is disposed between the plurality of directional antennas (five directional antenna sectors in FIG. 2) and the wireless communication modem 500 and a connection relationship therebetween is selectively determined. For example, when a current position of a transmission side ship or a position of its own ship (a reception side) is considered, a first directional antenna is selected to be connected with the modem 500 and when a circumstance such as positions of ships or a strength of a received signal is changed, antenna selection is changed from the first directional antenna to a second directional antenna and the changed second directional antenna is connected to the modem 50.

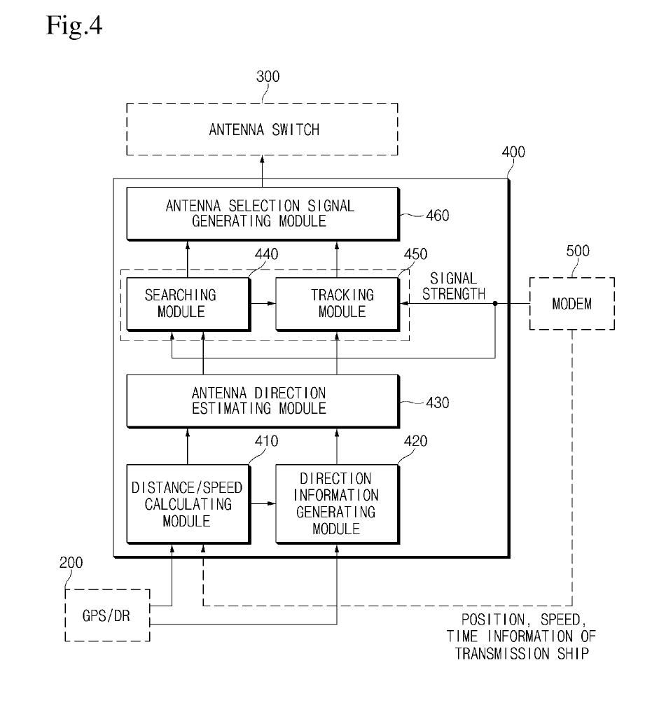

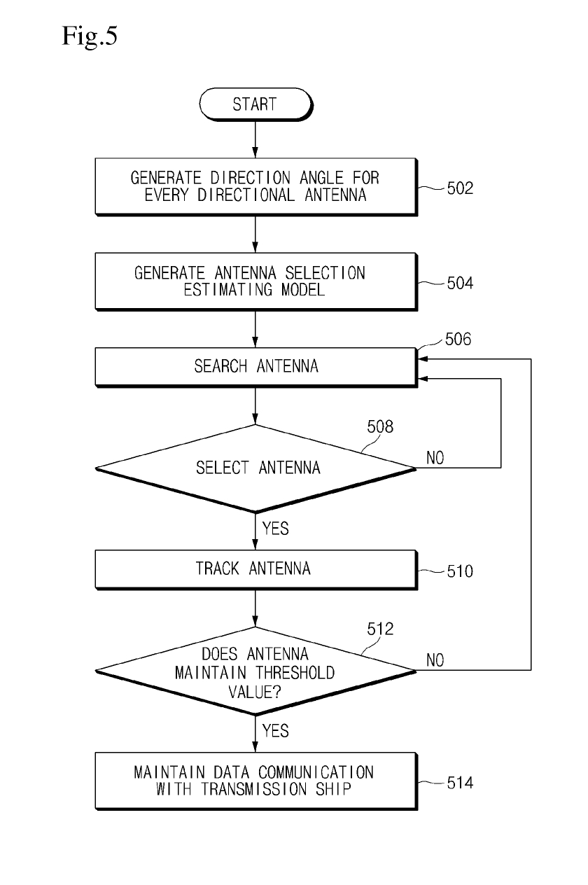

The switching determining unit 400 controls a switching operation of the above-mentioned antenna switch 300. In other words, the GPS/DR information of its own (reception side) ship and the GPS/DR information of the transmission side ship, information on the strength of the received signal which is received through the modem 500, and information of arrangement or directional coverage of the plurality of directional antennas are considered to control the operation of the antenna switch 300. Detailed configuration and operation thereof will be described below with reference to FIGS. 4 and 5.

The modem 500 receives a wireless signal which is received by the directional antenna to extract the information on the signal strength and a transmitted data signal. Here, the strength of the signal which is received from the selected directional antenna is transmitted to the switching determining unit 400 through the modem 500 so as to be used to search or track the directional antenna by the switching determining unit 400.

The AIS (automatic identification system) generates a unique identification code of the ship and the information may be coupled to the GPS/DR information to be transmitted to another ship.

FIG. 3 illustrates a plurality of directional antennas which is mounted in a ship according to an exemplary embodiment of the present invention.

Referring to FIG. 3, an exemplary embodiment in which five directional antennas are mounted in a ship is illustrated. One reference directional antenna is provided at a bow with respect to a deck (a line represented by zero degree in FIG. 3) which connects the bow and the stem and the remaining four directional antennas are radially provided with respect to the reference directional antenna so that all antennas cover 360 degrees. That is, five directional antennas are radially disposed at 72 degrees (directional antennas are disposed at zero degree, 72 degrees, 144 degrees, 216 degrees, and 288 degrees, respectively). Of course, according to another exemplary embodiment of the present invention, the directional antennas may be disposed with different arrangement in consideration of the coverages of the directional antennas.

When it is assumed that a beam width of one directional antenna is 90 degrees, the directional antennas may be desirably disposed with reference to a reference line of each of the antennas at 45 degrees at left and right sides. However, another arrangement is also available.

As described above, when it is assumed that five directional antennas are disposed such that the centers thereof are at zero degree, 72 degrees, 144 degrees, 216 degrees, and 288 degrees and the beam widths of the directional antennas are 45 degrees at the left and right sides to cover a total of 90 degrees, direction values which are covered by the antennas may be calculated such that −45 degrees <a direction value of the first antenna <+45 degrees, −45+72 degrees <a direction value of a second antenna <+45+72 degrees, −45+144 degrees <a direction value of a third antenna <45+144 degrees, −45+216 degrees <a direction value of a fourth antenna <45+216 degrees, −45+288 degrees <a direction value of a fifth antenna <45+288 degrees.

The direction values which are covered by the directional antennas are managed in advance by the switching determining unit 400.

When a stern direction of the ship which is initially set in this circumstance rotates about 70 degrees clockwise as illustrated in FIG. 3, the switching determining unit 400 which receives directivity information (for example, 70 degree clockwise rotation) of its own ship from the GPS/DR 200 manages in such a manner that reference direction values of the directional antennas are 0+70 degrees, 72+70 degrees, 144+70 degrees, 216+70 degrees, and 288+70 degrees with respect to a directional value of an absolute coordinate and the direction values which are covered by the directional antennas are also changed correspondingly. That is, the direction values which are covered by the antennas may be calculated such that −45+70 degrees <a direction value of the first antenna <45+70 degrees, −45+72+70 degrees <a direction value of the second antenna <45+72+70 degrees, −45+144+70 degrees <a direction value of the third antenna <45+144+70 degrees, −45+216+70 degrees <a direction value of the fourth antenna <45+216+70 degrees, −45+288+70 degrees <a direction value of the fifth antenna <45+288+70 degrees.

In this method, each ship continuously monitors and manages the direction angle information which is covered by the directional antenna mounted therein.

FIG. 4 is a block diagram illustrating a detailed configuration of the switching determining unit according to the exemplary embodiment of the present invention. Referring to FIG. 4, the switching determining unit 400 may include a distance/speed calculating module 410, a direction information generating module 420, an antenna direction estimating module 430, a searching module 440, a tracking module 450, and an antenna selection signal generating module 460.

Here, the GPS/DR 200, the antenna switch 300, and the modem 500 are illustrated for description of an operation of detailed configurations.

The distance/speed calculating module 410 calculates a position (direction), a distance, and a speed difference between a transmission side ship and its own ship (the reception side) such that the distance/speed calculating module 410 receives GPS/DR information of the transmission side ship which is transmitted from the transmission side ship through the modem and receives the GPS/DR information of the reception side ship and uses the information to perform an operation. The information on the position (direction), the distance, and the speed difference between the ships which is obtained as described above is transmitted to the antenna direction estimating module 430 which will be described below to be used for a tracking operation of the directional antenna.

The direction information generating module 420, as described in detail with reference to FIG. 3, has information on a reference direction and a direction angle of a beam width which are covered by every directional antenna which is mounted in the ship as an initial setting value and generates a coverage direction angle of each of the plurality of directional antennas based on the GPS/DR information of its own ship while moving and transmits the coverage direction angle to the antenna direction estimating module 430.

The antenna direction estimating module 430 receives the coverage direction angle information of each of the directional antennas of its own ship from the direction information generating module 420 and uses the information on the position (direction), the distance, and the speed difference between the transmission side ship and its own ship from the distance/speed calculating module 410 to estimate an optimal directional antenna sector at the reception side (for example, the first directional antenna) in a current circumstance and generate an estimating model concerning how the directional antenna sector suitably changes (changed from the first directional antenna to the fifth directional antenna) in accordance with a movement circumstance of the ships. Such an estimating model estimates the movement during a status when a problem occurs in a communication situation in which the GPS/DR information is not received from the transmission side ship in real time, to help to select a suitable directional antenna.

The searching module 440 continuously searches a strength of the received signal for every directional antenna 100 which is received from the modem 500 based on the estimating model which is generated in the antenna direction estimating module 430. Information which selects one directional antenna is initially generated through this process to be transmitted to the antenna selection signal generating module 460.

The tracking module 450 performs a tracking operation that refers to the estimating model which is generated in the antenna direction estimating module 430 and periodically receives the strength of the signal received from the currently selected directional antenna (for example, the first directional antenna) from the modem 500, and compares the strength of the received signal with a threshold value of the strength of the received signal which is already stored. If it is determined that the strength of the received signal does not exceed the threshold value, the tracking module 450 may select another directional antenna again to perform the tracking operation with the support of the antenna direction estimating module 430 or the searching module 440.

The antenna selection signal generating module 460 receives information from the searching module 440 and the tracking module 450 to transmit the antenna selection signal to the antenna switch 300.

FIG. 5 is a flowchart illustrating a multiantenna switching method according to an exemplary embodiment of the present invention.

A multiantenna switching method according to an exemplary embodiment of the present invention may include a step S502 of generating a direction angle for every directional antenna, a step S504 of generating an antenna selection estimating model, a step S506 of searching an antenna, a step S508 of selecting an antenna, a step S510 of tracking an antenna, a step S512 of confirming a threshold value of an antenna, and a step S514 of maintaining data communication with a transmission ship.

Hereinafter, above-described steps S502 to S514 will be described in detail with reference to FIGS. 1 to 4.

First, in step S502, the switching determining unit 400 generates a coverage direction angle for every directional antenna which is mounted in a ship in consideration of information such as mounting positions of a plurality of directional antennas in the ship, mounting method information, and a heading direction of a ship.

In step S504, the switching determining unit 400 receives GPS/DR information of a transmission side ship, that is, information on a direction, a position, a speed, and time and generates an antenna selection estimating model based on the GPS/DR information of a reception side ship and information on a coverage direction angle for every directional antenna. It means that a coverable directional antenna is selected in accordance with a movement circumstance of the transmission side ship and/or the reception side ship and the selected directional antenna is generated as a total estimating model.

In step S506, information on a strength of a wireless signal which is transmitted from the transmission side ship through each of the plurality of directional antennas is extracted through the modem 500 and information on the strength of the wireless signal which is currently received for every directional antenna is secured. In such an antenna searching process, a method which measures the strength of the signal which is received by the modem 500 while sequentially connecting one of the plurality of directional antennas with the modem 500 using the antenna switch 300 may be used during an initial setting process. The antenna searching process not in the initial setting process but in a process of changing the selected directional antenna into another directional antenna may be preferentially performed for directional antennas which are expected to have a high signal strength using coverage direction angle information, based on the antenna selection estimating model generated in step S504.

In step S508, one directional antenna is selected referring to the antenna search result. If a suitable directional antenna is not confirmed in this process, step S506 may be repeatedly performed.

In step S510, the selected directional antenna (for example, the first directional antenna) is periodically tracked.

In step S512, if a strength of the received signal through the first directional antenna which is currently tracked is lower than a threshold value so that the data communication is not available, the sequence returns to step S506 again to repeat the process of searching an antenna. The GPS/DR information is changed, for example, the transmission side ship and/or the reception side ship moves, the antenna selection estimating model may be generated again based on the changed information or some information thereby may be recollected. The sequence may restart from the process of searching an antenna based on the changed information. If it is finally determined that the second directional antenna is suitable, the second directional antenna is selected to perform the tracking process and maintain the data communication.

Further, the data communication between the transmission side ship and the reception side ship may be stably maintained with a predetermined satisfied received signal strength while stably changing a plurality of directional antennas in accordance with this method in step S514.

The method which has described regarding the exemplary embodiments disclosed in the specification may be directly implemented by hardware or a software module which is executed by a processor or a combination thereof. The software module may be stored in a RAM, a flash memory, a ROM, an EPROM, an EEPROM, a register, a hard disk, a detachable disk, a CD-ROM, or any other storage medium which is known in the art. An exemplary storage medium is coupled to a processor and the processor may read information from the storage medium and write information in the storage medium. As another method, the storage medium may be integrated with the processor. The processor and the storage medium may be stored in an ASIC (application specific integrated circuit). The ASIC may be stored in a user terminal. As another method, the processor and the storage medium may be stored in a user terminal as individual components.

It will be appreciated that the exemplary embodiments of the present invention have been described herein for purposes of illustration of the technical spirit of the present invention, and that various modifications, changes, substitutions may be made by those skilled in the art without departing from the gist of the present invention. Accordingly, the exemplary embodiments disclosed herein are not intended to limit the technical spirit of the present invention but explain the technical spirit of the present invention and the scope of the technical spirit of the present invention is not restricted by the exemplary embodiments. The protection scope of the present invention should be interpreted based on the following appended claims and it should be appreciated that all technical spirits included within a range equivalent thereto are included in the protection scope of the present invention.

What is claimed is:

1. A multiantenna switching system, comprising:
a plurality of directional antenna which is mounted in a ship to receive a wireless signal;
an antenna switch which selects one of the plurality of directional antennas;
a modem which is connected to the directional antennas through the antenna switch to extract a strength of a received signal; and
a switching determining unit which outputs an antenna selection signal to the antenna switch based on the strength of the received signal and GPS/DR information of a transmission side ship and its own ship.

2. The multiantenna switching system of claim 1, wherein the GPS/DR information of the transmission side ship is extracted and provided from the received signal by the modem.

3. The multiantenna switching system of claim 1, wherein the plurality of directional antennas each has a predetermined coverage direction angle and is radially mounted in the ship so as to cover all directions.

4. The multiantenna switching system of claim 1, wherein the received signal which is received through the plurality of directional antennas is transmitted through an omni antenna of the transmission side ship.

5. The multiantenna switching system of claim 1, wherein the switching determining unit includes:
a distance/speed calculating module which generates information on a position (direction), a distance or a speed difference between both ships based on the GPS/DR information of the transmission side ship and its own ship;
a direction information generating module which generates coverage direction angle information of each of the plurality of directional antennas based on the GPS/DR information of the transmission side ship and its own ship; and
an antenna direction estimating module which generates an antenna selection estimating model based on the information on a position (direction), a distance or a speed difference from the distance/speed calculating module and the coverage direction angle information of each of the plurality of directional antennas from the direction information generating module.

6. The multiantenna switching system of claim 5, wherein the switching determining unit further includes:
a searching module which searches information on a strength of a received signal which is received from the modem while sequentially selecting the plurality of directional antennas.

7. The multiantenna switching system of claim 6, wherein the searching module searches the information on the strength of the received signal through the plurality of directional antennas referring to the antenna selection estimating model.

8. A multiantenna switching method, comprising:
generating an antenna selection estimating model based on a coverage direction angle for every directional antenna and GPS/DR information of a transmission side ship and its own ship;
searching a strength of a received signal for every directional antenna referring to the antenna selection estimating model; and
selecting one of the plurality of directional antennas based on the strength of the received signal.

9. The multiantenna switching method of claim 8, further comprising:
monitoring whether the strength of the received signal maintains a threshold value while tracking the selected directional antenna; and
returning to the searching of a strength of a received signal for every directional antenna, when the strength of the received signal is lower than a threshold value.

10. The multiantenna switching method of claim 9, wherein the returned searching of a strength of a received signal includes updating the antenna selection estimating model.
